(19) United States
(12) Patent Application Publication
(10) Pub. No.: US 2007/0014382 A1
(43) Pub. Date: Jan. 18, 2007

(54) Reconfigurable transmitter

(75) Inventors: Niall Eric Shakeshaft, Helsinki (FI); Esko Antero Jarvinen, Espoo (FI); Marko Juhani Alanen, Espoo (FI); Vlad Gabriel Grigore, Vantaa (FI); Jorma Pertti Matero, Oulu (FI); Jarkko Henrikki Kesti, Oulunsalo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/182,521

(22) Filed: Jul. 15, 2005

(51) Int. Cl. H04L 27/00; H04L 25/03; H04L 25/49; H04K 1/02

(52) U.S. Cl. 375/297; 375/295; 375/296

(57) ABSTRACT

A transmission device and method are shown, wherein an amplification is implemented which can be changed between a switched operation mode and linear operation mode as desired, depending on which mode of operation best meets the needs of the radio system in use. This opens the possibility of using the same hardware for different systems.

### FIELD OF THE INVENTION

The invention relates to a transmission device and method for use in a transmission system, such as a cellular radio transmission system.

### BACKGROUND OF THE INVENTION

A power amplifier (PA) is a critical part of any radio transmitter. It amplifies the information-bearing RF (Radio Frequency) signal to a suitable power level for transmission. It is usually the last active section in the transmitter (TX) chain before the antenna. It typically also has the highest power consumption of any single part of the transmitter.

There are many different classes of power amplifiers. They can be distinguished from each other in terms of topology, or in the way in which they are driven or matched.

Most power amplifiers currently used in modern wireless communications are linear. This means that the input signal to the power amplifier is a fully modulated RF signal, containing all amplitude and phase modulation, already applied earlier in the transmitter. The power amplifier just provides gain, producing a ‘faithful copy’ of the input at the output, just at increased power.

“Class-A” refers to the most linear class of power amplifier, where the amplifier output follows the input waveform throughout the entire cycle of the RF input. This leads to the least distortion, but results in the least efficient class of power amplifiers—the power amplifier's bias current must be high enough so that the input RF signal never forces the transistor into a non-linear region, e.g., in the case of a bipolar type transistor, causes the device to go into saturation or cut-off.

By decreasing the conduction angle, through re-biasing the device so that the transistor is off for part of the input cycle, the efficiency of the power amplifier can be increased, but at the expense of non-linear distortion. Full conduction is Class-A. When conduction is 50% (i.e. only half of the input cycle is reproduced at the output) of the input cycle, the amplifier is in “Class-B”. When the amplifier is operating between these two classes then it is said to be “Class-AB”. Power amplifier designers try to achieve a trade-off between efficiency and non-linear distortion. The designer wishes the power amplifier to be as efficient as possible, while still meeting the wireless system spectrum requirements, e.g., adjacent channel leakage ratio, spectrum due to modulation, etc.

Designers also use various techniques to allow a linear power amplifier to operate with higher efficiencies, but with acceptable distortion. These include measures such as for example predistortion, adjustment of PA power supply with output power level and envelope tracking.

When conduction is at less than 50% of the input cycle then the amplifier is said to be operating in “Class-C”. This is an example of a fully non-linear amplifier. In the most efficient power amplifiers, the transistor operates as a switch. Amplifiers in this switched-mode category are “Class-D”, “Class-E” and “Class-F”, although Class-C and hard-driven or saturated Class-B amplifiers are also often placed in this group.

Non-linear, or switched-mode power amplifiers are unable to pass any signal containing amplitude modulation (AM) without massive distortion and spectral regrowth. However, if a constant-envelope RF signal without AM is used as an input, no distortion occurs. The output amplitude of these amplifiers is also, in the ideal case, directly proportional to the power supply. Thus, AM can be imposed onto the power amplifier supply in order to obtain complex modulation containing AM and phase modulation (PM) at the output of the power amplifier. Non-linear amplifiers are also very efficient, with theoretical efficiencies approaching 100%.

FIGS. 1 and 2 show the key differences between linear and switched-mode power amplifiers in terms of input, output and supply modulation.

FIG. 1 shows a schematic circuit diagram of a linear power amplifier 10 with a bias point set so that the power amplifier operates linearly. Also, the power supply (voltage VCC) must be set to a constant level high enough so that the power amplifier operates linearly. The input drive level must be at an appropriate level to keep the device operating linearly. An RF input signal with AM and PM is supplied at the input, and an amplified output signal with substantially equal AM and PM is obtained at the output.

FIG. 2 shows a schematic circuit diagram of a switched-mode power amplifier 12 with a bias point set such that the power amplifier acts as a switch. As regards the power supply, an AM is introduced to the switched-mode power amplifier through its supply node (e.g. modulated supply voltage VCC). An RF input signal with solely PM can be supplied at the input, and an amplified output signal with AM and PM can be obtained at the output, while the AM, which my have been separated from the input signal, is added through the supply node. When operating in switched-mode the input drive level to the power amplifier must be high enough to hard-switch the power amplifier, i.e., the input must keep the amplifier in gain compression. Thus, in the linear mode, that is to say, when operating in the linear mode, the input power to the power amplifier will usually be less than when it is operating in switched-mode.

One form of transmitter using the switched-mode power amplifier of FIG. 2 was first proposed in the 1950s and called Envelope Elimination and Restoration (EER). The RF signal is first produced at either intermediate frequency (IF) or RF. The envelope is detected and fed forward to the PA power supply. The signal then goes through a limiter to leave a PM-only signal before being fed to the RF input of the power amplifier. This concept of applying an amplitude-modulated signal to the supply of a non-linear amplifier has been well known for many years as the “Kahn Technique”. This architecture often includes an up-conversion as well, sometimes with an offset-loop approach.

In recent years, especially since the advent of fast, delta-sigma fractional-N phase-locked loops (PLLs), the EER concept has been developed and refined further. Envelope elimination and restoration is no longer necessary, but rather the amplitude and phase signals can be created in the digital baseband. The amplitude signal is then fed to a digital-to-analog converter (DAC) and on to the non-linear power amplifier power supply. The phase signal is differentiated to obtain a signal describing frequency and then this is used to modulate a PLL synthesizer. This is often a fractional-N PLL with the frequency data put into a sigma-delta modulator to obtain FM modulation.

The most efficient way to implement the fast power supply in the AM path is with a switched-mode power supply (SMPS). The bandwidth of the SMPS is however limited by the achievable switching speed.

In a polar transmitter architecture, I and Q signals are transformed from Cartesian coordinates (sine and cosine) into polar coordinates (amplitude and phase). The amplitude and phase information are separated and sent down separate paths until they are recombined in the switched-mode power amplifier. As already mentioned above, the phase information extracted from the original signal (either constant envelope or non-constant envelope) is transformed into a constant envelope signal. This is achieved by phase modulating a phase-locked loop designed to output the desired transmit frequencies. The resulting signal may now be amplified by compressed amplifiers without concern of distorting amplitude information. The extracted amplitude information is used to modulate the power supply of the power amplifier.

However, switched-mode transmitters are also limited in terms of their dynamic range. This is a function not just of the switched mode power amplifier, which exhibits extreme amplitude and phase non-idealities at low voltage, but also of the switched-mode power supply—the lowest available output voltage is limited both by the available switching duty cycle within the SMPS and the ripple present from the switching action.

This dynamic range issue may be the most difficult problem to address in switched-mode transmitters, such as polar transmitters. Systems built around various versions of Code Division Multiple Access (CDMA) schemes (e.g. 3GPP WCDMA (3^{rd} Generation Partnership Project Wideband CDMA) or CDMA2000) have very large power control ranges, in excess of 70 dB. However, the power control range that is available from a polar transmitter might only be around 30 dB. This may be enough for GSM (Global System for Mobile communication) or GSM-EDGE (Enhanced Date for GSM Evolution) type systems, but not for CDMA type systems where large power-control ranges are required.

### SUMMARY OF THE INVENTION

It is an object of the invention to provide a highly efficient transmission device and method, by means of which flexible use in all type of transmission systems can be ensured.

This object is achieved by a transmission device comprising:
amplifier means configured to be operable in a switched operation mode and in a linear operation mode;
switching means for selectively controlling said amplifier means to operate either in said switched operation mode or in said linear operation mode.

Furthermore, the above object is achieved by a transmission method comprising the step of controlling an amplification of a transmission signal so as to selectively amplify said transmission signal either in a switched operation mode or in a linear operation mode based on a transmission system through which said transmission signal is transmitted.

Accordingly, power efficiency of the transmission can be increased through selective use of the switched-mode approach whenever possible, e.g., if the power control range is sufficient. Moreover, the ability to switch to linear mode for wide dynamic range systems opens the possibility of using the same hardware for different systems and thus leads to an increased flexibility.

Power supply means may be provided for supplying power to the amplifier means, wherein the power supply means are controlled in response to the switching means so as to generate a power supply with an amplitude modulation if the switched operation mode is selected, and to generate a constant power supply if the linear operation mode is selected. Hence, in the switched operation mode, the amplitude modulation can be selectively reintroduced through the power supply signal.

Additionally, at least one of predistortion, adjustment of supply voltage with output power and envelope tracking may be applied in the linear operation mode, so that a limited amplitude modulation of the supply power is obtained in the linear operation mode. Thereby, efficiency can be improved.

Furthermore, signal processing means may be provided for generating an amplifier input signal supplied to the amplifier means, wherein the signal processing means may be controlled in response to the switching means so as to generate said amplifier input signal with a constant envelope if said switched operation mode is selected and to generate said amplifier input signal with an amplitude modulation if said linear operation mode is selected. As an example, the switching means may comprise first switching means for selectively connecting either an envelope signal corresponding to the amplitude modulation or a constant power control signal to the power supply means.

Additionally, extraction means may be provided for extracting the amplitude modulation from an input signal of the transmitter device. In particular, the extraction means may comprise conversion means for converting an in-phase component and a quadrature component of the input signal into an amplitude signal and a phase signal, and wherein the amplitude modulation is derived from the amplitude signal. Thereby, a reconfigurable polar transmitter is provided which can be driven by a Cartesian I/Q signal. Variable delay means may be configured to selectively adjust a relative delay between the extracted amplitude modulation and the phase modulation of the input signal in response to the switching means.

The signal processing means may comprise amplitude modulation means controlled in response to the switching means. The amplitude modulation means can be set to a constant output state if the switched operation mode is selected. As an example, the switching means may comprise second switching means for selectively connecting either an envelope signal corresponding to the amplitude modulation or a constant power control signal to a modulation input of the amplitude modulation means.

As an additional measure, predistortion means may be provided for applying selective predistortion to a carrier input signal of the amplitude modulation means in order to selectively compensate for characteristics of the amplitude modulation means if the linear operation mode is selected.

The operation mode may be selected or set by using biasing means for changing a bias signal of the amplifier means in response to the switching means. The biasing means may comprise at least one of a programmable current source for generating a variable bias current and a programmable voltage source for generating a variable bias voltage.

Further advantageous developments are described below.

### BRIEF DESCRIPTION OF THE DRAWINGS

In the following, the present invention will be described based on an embodiment with reference to the accompanying drawings in which:

FIG. 1 shows a schematic diagram of a linear power amplifier;

FIG. 2 shows a schematic diagram of a switched-mode power amplifier;

FIG. 3 shows a schematic block diagram of a reconfigurable polar transmitter according to an embodiment of the present invention in a switched operation mode; and

FIG. 4 shows a schematic block diagram of a reconfigurable polar transmitter according to the embodiment in a linear operation mode.

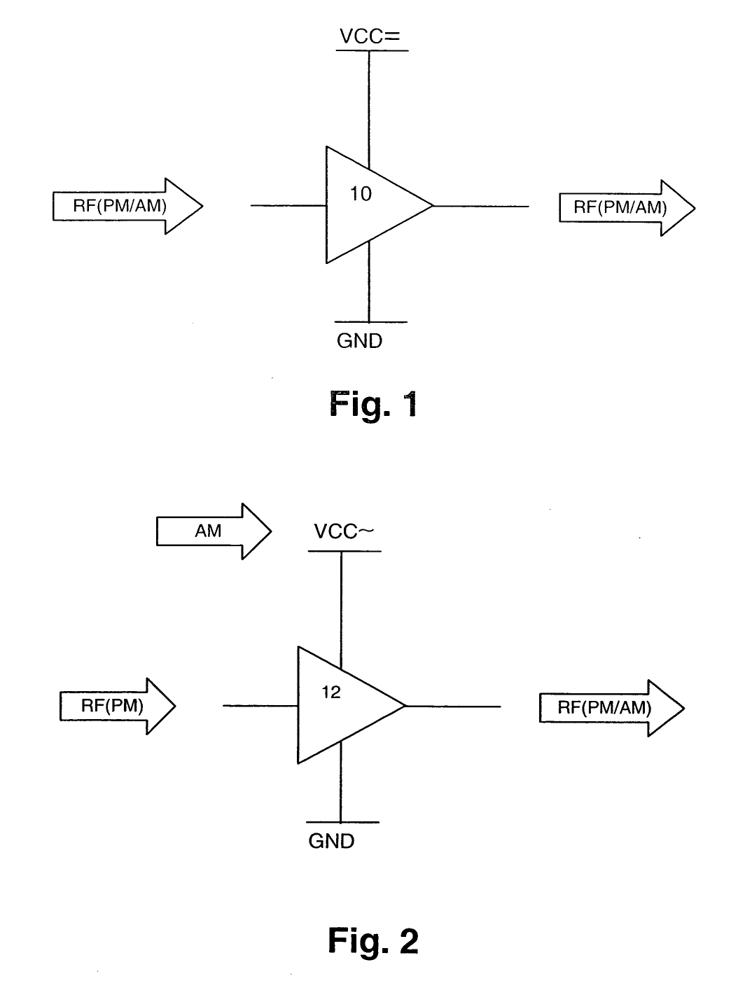

### DESCRIPTION OF THE PREFERRED EMBODIMENT

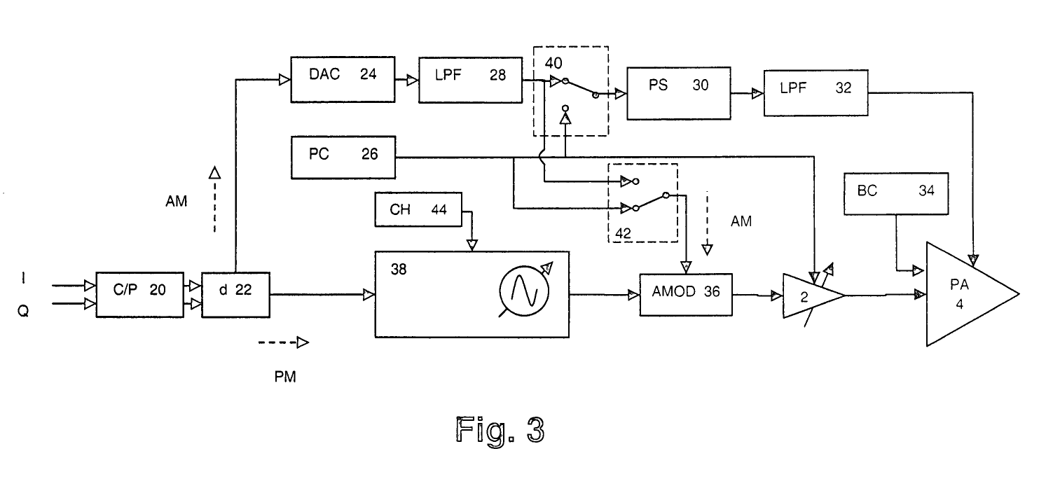

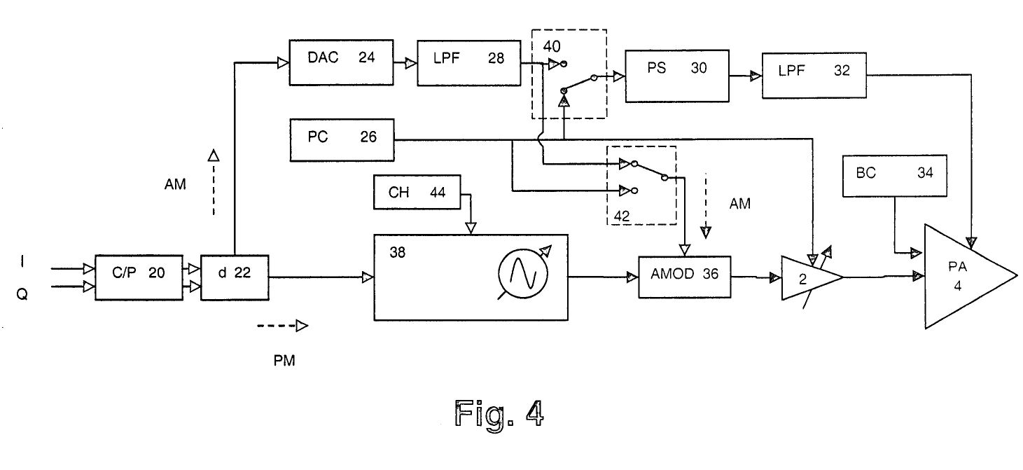

The embodiment of the present invention will now be described in connection with a reconfigurable polar transmitter as shown in FIGS. 3 and 4 to be used in a cellular radio system. As an example, reconfigurable polar transmitter can be part of a mobile terminal device, such as a mobile phone or mobile computer terminal, or a base station device. The circuitry shown in FIGS. 3 and 4 can be integrated as a single chip or a chip set to be assembled in at least one of the above mentioned mobile terminal device or base station device.

According to the embodiment, the polar transmitter can be changed between switched-mode operation (switched operation mode) and a linear-mode operation (linear operation mode) as desired, depending on which mode of operation best meets the needs of the radio system in use.

When operating in switched-mode as shown in FIG. 3, the power supply 30 of a power amplifier 4 is amplitude modulated and the input of the power amplifier 4 is supplied with a constant envelope RF signal with phase modulation only. The power amplifier 4 is biased by a biasing circuit 34 so that it operates in a switched-mode e.g. Class E, F or Saturated Class-B. The input drive level is set by the preceding stages to a suitable level.

When operating in linear mode as shown in FIG. 4, the power amplifier 4 is re-biased by the biasing circuit 34 so that the power amplifier 4 operates in Class A or AB. The input signal to the power amplifier 4 is modulated with both AM and PM. To achieve this, an amplitude modulator 36 must be included in the transmission chain or branch. At least one variable gain amplifier 2 provides for the required dynamic range.

Efficiency-improving techniques associated with linear transmitters can be used when the power amplifier 4 is in linear mode, e.g. predistortion, adjustment of supply voltage with output power and envelope tracking. A power supply unit 30 for supplying power to the power amplifier 4 can be variable in bandwidth, switching between static power control mode, envelope tracking and full amplitude modulation depending on the circumstances.

By controlling switching states of a first switching unit 40 and a second switching unit 42, the transmitter can be selectively set to linear (FIG. 4) or switched-mode (FIG. 3) as desired. This can be achieved by a manual user operation or by a detection-based automatic operation depending on the selected transmission system.

For example, if a transmitting systems with low dynamic range requirements (e.g. GSM) is detected or determined to be used by the transmitter, the power amplifier 4 can be operated in the switched operation mode as shown in FIG. 3. This is achieved by correspondingly controlling the first switching unit 40 to connect the power supply unit 30 to an upper branch through which an amplitude modulation or envelope signal (AM) derived from an I/Q input signal is supplied. Additionally, the second switching unit 42 is controlled to connect a constant output signal of a power control circuit 26 to a modulation input of the amplitude modulator 36. Consequently, an amplitude-modulated power signal is supplied to the power amplifier 4 and the envelope of the input signal of the power amplifier 4 is kept substantially constant.

The output signal of the power control circuit 26 is also used for controlling a variable gain amplifier (VGA) 2 to set the required dynamic range and maximum gain for driving the power amplifier 4.

When the transmitter is being used in a system requiring high dynamic range (e.g. WCDMA), the power amplifier 4 can be operated in the linear operation mode as shown in FIG. 4. This is achieved by correspondingly controlling the first switching unit 40 to connect the power supply unit 30 to the constant output signal of the power control circuit 26. Additionally, the second switching unit 42 is controlled to connect the upper branch through which the amplitude modulation or envelope signal (AM) derived from the I/Q input signal is supplied to the modulation input of the amplitude modulator 36. Consequently, an amplitude-modulated input signal is supplied to the power amplifier 4 and the envelope of the power supply signal of the power amplifier 4 is kept substantially constant.

The power amplifier 4 must be designed so that it can operate in both switched operation mode and linear operation mode with acceptable performance. Specifically, a bias signal supplied to the power amplifier 4 by a biasing circuit 34 can be set e.g. by programmable current and/or voltage sources. These bias voltages and/or bias currents are set to bias the power amplifier 4 to bias values suitable for either the linear operation mode or the switched operation mode depending on the transmission system, i.e. the switching state of the first and second switching units 40, 42. Thus, the biasing circuit 34 may have a control input (not shown) which is controlled by the same control signal or information supplied to the first and second switching unit 40, 42.

As an additional measure, it may be necessary to apply a predistortion to the transmission chain (lower branch in FIGS. 3 and 4) in order to compensate for AM/AM and AM/PM distortion characteristics of the power amplifier 4 when it is operating in the switched operation mode. When operating in the linear operation mode, it may be desirable to also use other measures such as predistortion, adjustment of the power supply with output power level or envelope tracking in order to increase efficiency of the power amplifier 4. The predistortion may be applied by a corresponding predistortion unit (not shown) arranged in the transmission chain.

The power supply unit 30 supplies the power signal via a first low pass filter 32 for removing unwanted high frequency components or spurious signals and may typically be a switched mode power supply, although it could also be implemented as a linear regulator, a combination of a switched mode power supply and a linear regulator, a linear amplifier, a switched-capacitor supply or the like.

In the upper branch or amplitude path used for supplying the amplitude information or envelope signal, a digital-to-analog converter (DAC) 24 is provided if the transmitter receives digital I and Q data streams at its input. In some implementations the DAC 24 in the amplitude path could be eliminated and a digital or PWM (pulse width modulation) signal passed to the switched-mode power supply unit 30. The DAC 24 is followed by a second low pass filter 28 for removing unwanted high frequency components or spurious signals.

A back end RF-IC 20 will take the digital I and Q data streams after pulse shaping and convert them to amplitude and phase signals. One way to do this is with some kind of Cordic algorithm applied by a Cordic processor. The Cordic processor transforms the Cartesian coordinates (sine and cosine) of the I and Q data streams into polar coordinates (amplitude and phase). The amplitude and phase information are separated and supplied to separate paths, i.e., the upper amplitude branch and the lower transmission chain, respectively.

The amplitude information is fed to the DAC 24. In the switched operation mode of FIG. 3, this DAC 24 provides an analog reference or control signal for the power supply unit 30. In the linear operation mode of FIG. 4, this DAC 24 provides an analog AM signal for the amplitude modulator 36. The amplitude modulator 36 can be implemented as a mixer, variable gain amplifier (e.g. a current-steering variable gain amplifier), a non-linear or switched-mode buffer with modulated supply, a variable attenuator or some other block which provides an amplitude modulation function. The precise implementation will depend on the semiconductor technology to be used and the system requirements. The amplitude modulator 36 can be set to a constant output state when the transmitter is running in switched operation mode, by supplying the output signal of the power control circuit 26 to the modulation input of the amplitude modulator 36. Additionally, it may be necessary to apply a digital predistortion by a suitable predistortion unit (not shown) to compensate for the AM/AM and AM/PM characteristics of the amplitude modulator 36 when the transmitter is running in the linear operating mode.

A variable delay unit 22 is provided to have the capability to adjust the relative delays between the upper amplitude path and the lower phase path in the transmission chain so that these modulation signals arrive at either the power amplifier 4 (when the transmitter is running in the switched operation mode) or the amplitude modulator 36 (when the transmitter is running in the linear operation mode) at the same time.

The required power control dynamic range can be provided by the VGA 2 or a VGA line-up after the amplitude modulator 36. Furthermore, it may be necessary, for some systems, to add a bandpass filter (not shown) before the power amplifier 4 in order to filter noise and/or spurious signals.

The phase information or phase modulation is differentiated and then fed to a PLL synthesizer modulator 38, which can be implemented either as a single-point FM modulator (e.g. fractional N synthesizer) or with a two-point modulation, as desired. A voltage-controlled oscillator (VCO, not shown) provided in the PLL synthesizer modulator 38 may be running at the channel frequency or multiples of the channel frequency (e.g. 2× or 4×). When the VCO runs on a multiple of the channel frequency, the PLL synthesizer modulator 38 has a frequency divider to convert the VCO frequency (e.g. divided by 2 or 4) to the actual channel frequency. This will depend on the number of bands to be supported and their frequency allocations as supplied from a channel information provided as a control information or stored in a (programmable) channel unit or memory 44. Additionally, the characteristics of the PLL synthesizer modulator 38 may be measured and characterized, i.e. for single-point PLL modulation with pre-emphasis or two-point PLL modulation.

The proposed transmitter according to the above-described embodiment provides advantages relative to a traditional IQ modulator approach in that power amplifier efficiency is improved by using the switched-mode approach whenever possible. Moreover, advantages relative to “pure” switched-mode transmitters are achieved by the ability to switch to the linear operation mode for wide dynamic range systems, which opens the possibility of using the same hardware for different systems.

In summary, a transmission device and method have been described based on the embodiment of FIGS. 3 and 4, wherein an amplification can be changed between a switched operation mode and linear operation mode as desired, depending on which mode of operation best meets the needs of the radio system in use. This opens the possibility of using the same hardware for different systems.

It is to be noted that the present invention is not restricted to the above embodiment and can be implemented in any transmitter architecture having an amplifier circuit or device which can be configured to selectively operate either in a linear operation mode or in a switched operation mode. The first and second switching units 40, 42 may be implemented by using any kind of switching element, e.g. active or passive semiconductor elements or switching circuits. Furthermore, the only one or more than two switching units may be provided to achieved the selective supply of the amplitude information to either the amplitude modulator 36 or the power supply input of the power amplifier 4. In general, the present invention is intended to cover any embodiment or modification where an amplifier can be selectively switched between a linear mode of operation and a switched mode of operation. The preferred embodiments may thus vary within the scope of the attached claims.

1. A transmission device comprising:
a) amplifier means (4) configured to be operable in a switched operation mode and in a linear operation mode; and
b) switching means (40, 42) for selectively controlling said amplifier means to operate either in said switched operation mode or in said linear operation mode.

2. The device of claim 1, further comprising power supply means (30) for supplying power to said amplifier means (4), said power supply means (30) being controlled in response to said switching means (40) so as to generate a power supply with an amplitude modulation if said switched operation mode is selected and to generate a constant power supply if said linear operation mode is selected.

3. The device of claim 1, further comprising efficiency-improving means for applying at least one of predistortion, adjustment of supply voltage with output power and envelope tracking, when said amplifier means (4) is in said linear operation mode.

4. The device of claim 2, wherein said switching means comprise first switching means (40) for selectively connecting either an envelope signal corresponding to said amplitude modulation or a constant power control signal to said power supply means (30).

5. The device of claim 1, further comprising signal processing means (36, 38) for generating an amplifier input signal supplied to said amplifier means (4), said signal processing means (36, 38) being controlled in response to said switching means (42) so as to generate said amplifier input signal with a constant envelope if said switched operation mode is selected and to generate said amplifier input signal with an amplitude modulation if said linear operation mode is selected.

6. The device of claim 2, further comprising extraction means (20, 22) for extracting said amplitude modulation from an input signal of said transmission device.

7. The device of claim 6, wherein said extraction means (20, 22) comprises conversion means (20) for converting an in-phase component and a quadrature component of said input signal into an amplitude signal and a phase signal, and wherein said amplitude modulation is derived from said amplitude signal.

8. The device of claim 5, wherein said signal processing means (36, 38) comprises amplitude modulation means (36) controlled in response to said switching means (42).

9. The device of claim 8, wherein said amplitude modulation means (36) is set to a constant output state if said switched operation mode is selected.

10. The device of claim 9, wherein said switching means comprises second switching means (40) for selectively connecting either an envelope signal corresponding to said amplitude modulation or a constant power control signal to a modulation input of said amplitude modulation means (36).

11. The device of claim 8, further comprising predistortion means for applying selective predistortion to a carrier input signal of said amplitude modulation means (36) in order to selectively compensate for characteristics of said amplitude modulation means (36) if said linear operation mode is selected.

12. The device of claim 1, further comprising biasing means (34) for changing a bias signal of said amplifier means in response to said switching means, so as to set said amplifier means either into said switched operation mode or into said linear operation mode.

13. The device of claim 12, wherein said biasing means (34) comprise at least one of a programmable current source for generating a variable bias current and a programmable voltage source for generating a variable bias voltage.

14. The device of claim 6, further comprising variable delay means (22) configured to selectively adjust a relative delay between said extracted amplitude modulation and a phase modulation of said input signal in response to said switching means (40, 42).

15. A mobile terminal device for a cellular radio system, said mobile terminal device comprising a transmission device as claimed in claim 1.

16. A base station device for a cellular radio system, said base station device comprising a transmission device as claimed in claim 1.

17. A chip set comprising at least one integrated circuit having integrated thereon a transmission device as claimed in claim 1.

18. A transmission method comprising the step of controlling an amplification of a transmission signal so as to selectively amplify said transmission signal either in a switched operation mode or in a linear operation mode based on a transmission system through which said transmission signal is transmitted.

19. The method of claim 18, further comprising the steps of generating a power supply with an amplitude modulation if said switched operation mode is selected and generating a constant power supply if said linear operation mode is selected.

20. The method of claim 18, further comprising the step of applying in said linear operation mode at least one of predistortion, adjustment of supply voltage with output power and envelope tracking.

21. The method of claim 18, further comprising the step of generating an amplifier input signal with a constant envelope if said switched operation mode is selected and generating an amplifier input signal with an amplitude modulation if said linear operation mode is selected.

22. The method of claim 19, further comprising the step of extracting said amplitude modulation from an input signal to be transmitted by said transmission method.

23. The method of claim 22, wherein said step of extracting comprises converting an in-phase component and a quadrature component of said input signal into an amplitude signal and a phase signal, wherein said amplitude modulation is derived from said amplitude signal.

24. The method of claim 21, further comprising the step of applying selective predistortion to a transmission chain in order to selectively compensate for characteristics of said amplitude modulation if said linear operation mode is selected.

25. The method of claim 18, further comprising the step of changing a bias signal used in said amplification, so as to set said amplification either into said switched operation mode or into said linear operation mode.

26. The method of claim 22, further comprising the step of selectively adjusting a relative delay between said extracted amplitude modulation and a phase modulation of said input signal based on the selected operation mode.
